(19) United States
(12) Patent Application Publication
(10) Pub. No.: US 2021/0346223 A1
(43) Pub. Date: Nov. 11, 2021

(54) DENTAL AND MEDICAL BARRIER

(71) Applicants: Emanuel Mizrahi, Glen Head, NY (US); Bita Pouyafar, Old Westbury, NY (US)

(72) Inventors: Emanuel Mizrahi, Glen Head, NY (US); Bita Pouyafar, Old Westbury, NY (US)

(21) Appl. No.: 17/316,654

(22) Filed: May 10, 2021

Related U.S. Application Data
(60) Provisional application No. 63/022,707, filed on May 11, 2020.

(51) Int. Cl. A61G 10/00; A61G 15/10; A61G 15/16

(52) U.S. Cl. CPC A61G 10/005; A61G 15/16; A61G 15/10

(57) ABSTRACT

A barrier is provided for dental or medical procedures on patient. The barrier has a frame, a clear top connected to the frame and a disposable plastic sheeting connected around substantially an entire perimeter of the clear top, the disposable plastic sheeting covering the frame. The frame is supportable on a chair or table for supporting patient, the barrier intended to cover at least a head and portion of shoulders of a patient.

### RELATED APPLICATION

This application claims the benefit of priority from U.S. Provisional Patent Application No. 63/022,707, filed on May 11, 2020, the entirety of which is incorporated by reference.

### FIELD OF THE INVENTION

This application relates to a barrier. More particularly, this application relates to a barrier to separate a patient from a physician or dentist, allowing access to conduct a procedure.

### BACKGROUND AND PRIOR ART

During a time of a pervasive infectious disease there is a heightened need to provide physical barriers between patients and dentists, dental hygienists, or other medical professionals. This helps prevent the spread of disease and viruses, but also provides a more comfortable sense of wellbeing to both patients and professionals.

For example, a dental aerosol is any airborne contaminant released during a dental procedure, for example from the mouth of patient during dental procedure. These particles remain suspended in the area for hours and can infect surfaces and tools. They can also be re-aspirated by dental staff members and people up to 30 feet away from the source and beyond.

The use of physical barriers in medical and dental procedures is known. However, typically these barriers are worn by the physician or dentist, usually in the form of a wearable face shield. These can be uncomfortable and difficult to work with (e.g. breath can fog the shield).

### SUMMARY AND DESCRIPTION

The present arrangement overcomes the drawbacks associated with the prior art and provides a barrier that rests on a chair or table (or is supported from the floor) to cover patient in the chair or on the table. The barrier is configured to substantially cover the face and upper shoulders of the patient. The barrier is positioned between the patient and the dentists or physician and protects both equally while alleviating the need for the dentist to wear an uncomfortable face shield. A disposable plastic sheeting can be attached to the frame and disposed of after each patient. When in use, vacuum suction tubes may put in place to keep the area under the barrier and within the plastic sheeting under a negative pressure to keep the aerosol particles of leaking out through the openings for the dentist's hands and the patient's body.

Such an arrangement reduces the possibility of transmission of viruses and disease between patient and dentist while still providing an ideal amount of working space for the dentist or physician to maneuver their arms about the patients head as required for the procedure.

To this end a barrier is provided for dental or medical procedures on patient. The barrier has a frame, a clear top connected to the frame and a disposable plastic sheeting connected around substantially an entire perimeter of the clear top, the disposable plastic sheeting covering the frame. The frame is supportable on a chair or table for supporting patient, the barrier intended to cover at least a head and portion of shoulders of a patient.

### BRIEF DESCRIPTION OF THE DRAWINGS

The present invention can be best understood through the following description and accompanying drawing, wherein:

FIG. 1 shows a two-stage assembly of lateral base frames and a frame base connector of a barrier, in accordance with one embodiment;

FIG. 2 shows a two-stage assembly of vertical support rods of the barrier, in accordance with one embodiment;

FIGS. 3 and 4 show a two-stage assembly of an instrument holder (FIG. 3) and instrument tray (FIG. 4) to vertical support rods of the barrier in accordance with one embodiment;

FIG. 5 shows a two-stage attachment of a polycarbonate top to vertical support rods, with notches for slidable instrument holder and instrument tray in accordance with one embodiment;

FIG. 6 shows a two-stage securing of the polycarbonate top to vertical support rods in accordance with one embodiment;

FIG. 7 shows two-stage attachment of plastic sheet clips to the polycarbonate top in accordance with one embodiment;

FIG. 8 shows table/chair brackets for supporting the barrier, connected with locking wedges onto lateral frame base and frame base connector in accordance with one embodiment;

FIG. 9 shows a completed assembly of the barrier with disposable plastic sheeting over the framework in accordance with one embodiment; and

FIG. 10 shows the completed assembly of the barrier with disposable plastic sheeting over the framework, also having the vacuum hose connected through an upper opening in the polycarbonate top in accordance with one embodiment.

### DETAILED DESCRIPTION

In one embodiment the present arrangement relates to a barrier 1 for blocking aerosols from a patient during a dental procedure. For the purposes of illustrating the salient features of the invention barrier 1 is described in terms of dental procedures, but it is contemplated that barrier 1 may be used in conjunction with any upper body medial or hygienic procedures. In general, the shape of barrier 1 described herein is to cover the head and upper shoulders of patient and is dimensioned such that a dentist can clearly see the patient and mouth area while having adequate room for movement of their hands during the procedure.

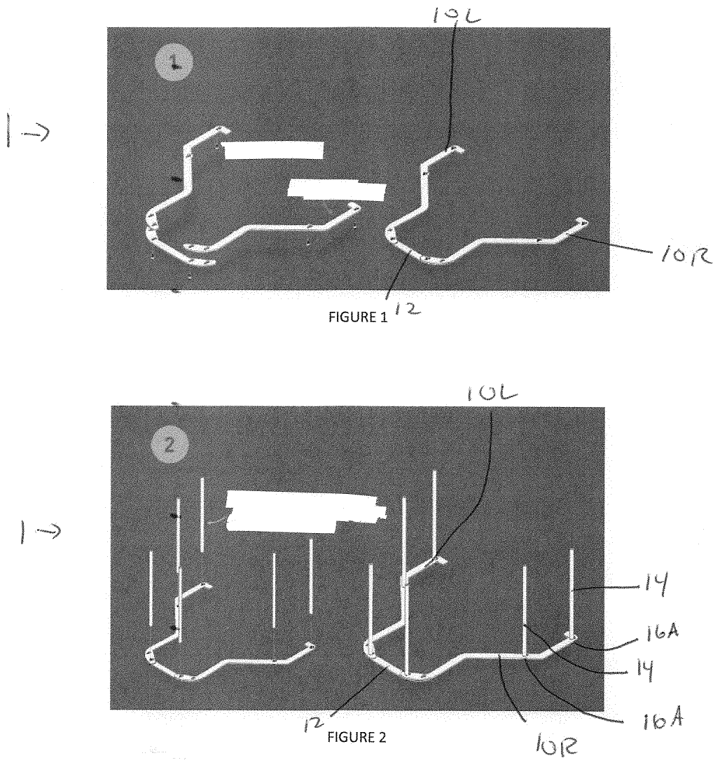

Turning to the basic construction of barrier 1, as illustrated in FIG. 1, two lateral frame bases 10L and 10R are connected together via a frame base connector 12, secured with screws or optional snap fit arrangements. Lateral frame bases 10L and 10R are shaped to set the basic side dimensions of barrier 1 with expanded width to accommodate a patient's shoulders. Frame base connector 12 is of sufficient length to span the width of a patient's head when seated within a reclined dental chair. Lateral frame bases 10L and 10R as well as frame base connector 12 are preferably made of aluminum but could be constructed of any durable and sturdy metal or polymer.

FIG. 2 shows the connection of six vertical support rods 14 to openings in lateral frame bases 10L and 10R and frame base connector 12. Such connection can be made with rod base thumb screws 16A. As with the base elements, vertical support rods 14 are preferably made of aluminum and may dimensioned to about 1-2 feet in length (or more or less depending on specific design parameters) sufficient to provide clearance for a patient's head thereunder as well as to allow room for a dentist's arms to conduct the various dental and hygienic procedures, including room for their instruments.

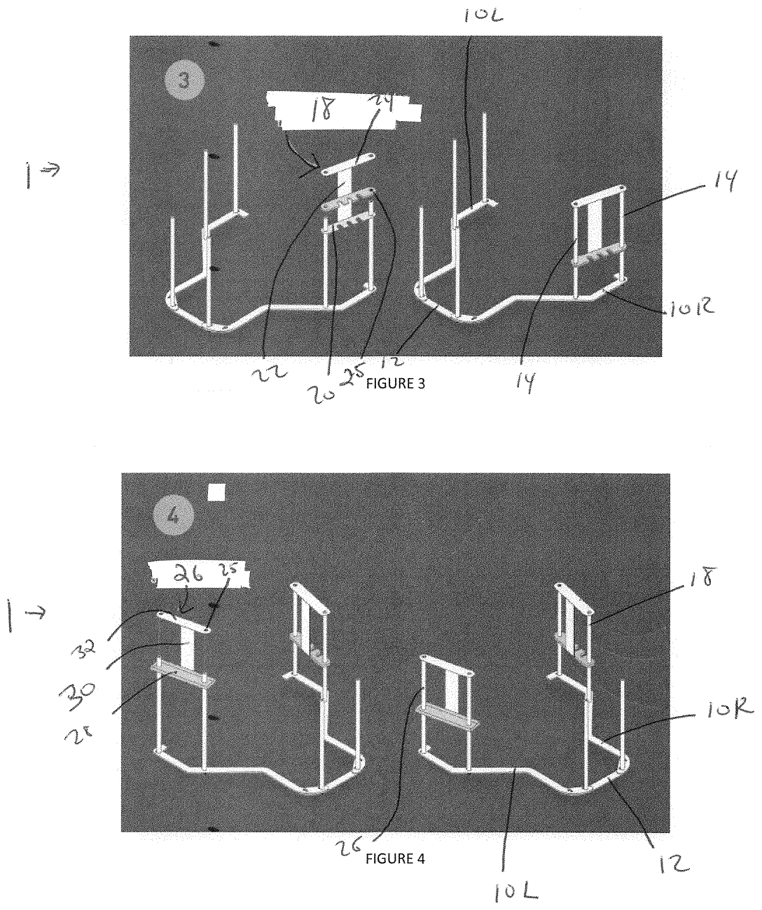

FIG. 3 shows the attachment of an instrument holder 18 to two of vertical support rods 16 extending from lateral frame base 10R. Instrument holder 18 may include instrument clip 20, vertical rail 22 and top piece 24. Instrument clip 20 and top piece 24 both have lateral openings 25 for sliding onto vertical support rods 16. Similarly, FIG. 4 shows the attachment of an instrument tray 26 to two of vertical support rods 16 extending from lateral frame base 10L. Instrument tray 26 may include tray 28, vertical rail 30 and top piece 32. Instrument tray 26 and top piece 32 both have lateral openings 25 for sliding onto vertical support rods 16, similar to instrument holder 18. Both instrument clip 20 of instrument holder 18 and tray 28 of instrument tray 26 may be made of stainless steel (for medical sanitary reasons), but the construction material is not limited in that respect.

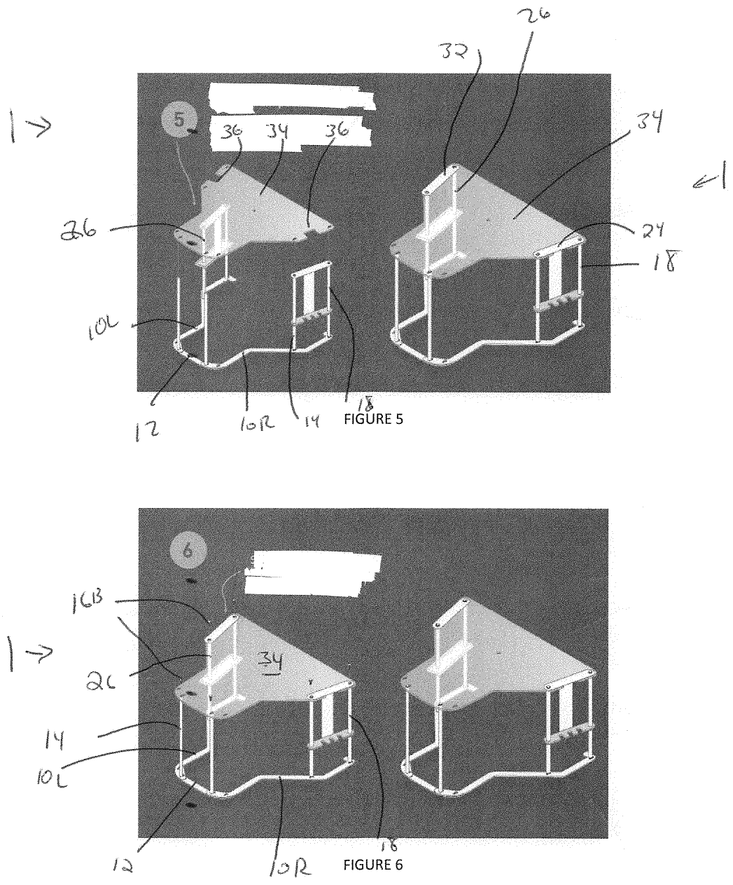

Turning to the top of barrier 1, as shown in FIG. 5, a polycarbonate top 34 is dimensioned to match the shape of lateral frame base 10R and 10L as well as frame base connector 12. Polycarbonate top 34 has two cut out notches 36 for receiving vertical rails 22 and 30 of instrument holder 18 and instrument tray 26. As shown in FIG. 5 polycarbonate top 34 is placed on top of vertical support rods 16 and fit so that notches 36 fit around vertical rails 22 and 30 and under top pieces 24 and 32 so that instrument holder 18 and instrument tray 26 are fixed in place. In this arrangement, when polycarbonate top 34 is placed on top of vertical support rods 14, vertical rails 22 and 30 passes through receiving notch 36 and top pieces 24 and 32 of instrument holder 18 and instrument tray 26 rests on top of polycarbonate top 34. At this point, as shown in FIG. 6, polycarbonate t op 34 is then screwed in place on top of vertical support rods 16 and screwed into place with top piece thumb screws 16B.

As shown in FIG. 7 after polycarbonate top 34 is secured, a series of plastic clips 38 are secured to the upper surface around the outer perimeter. The attachment of clips 38 can be done for example by peel and stick surfaces on the bottom of clips 38.

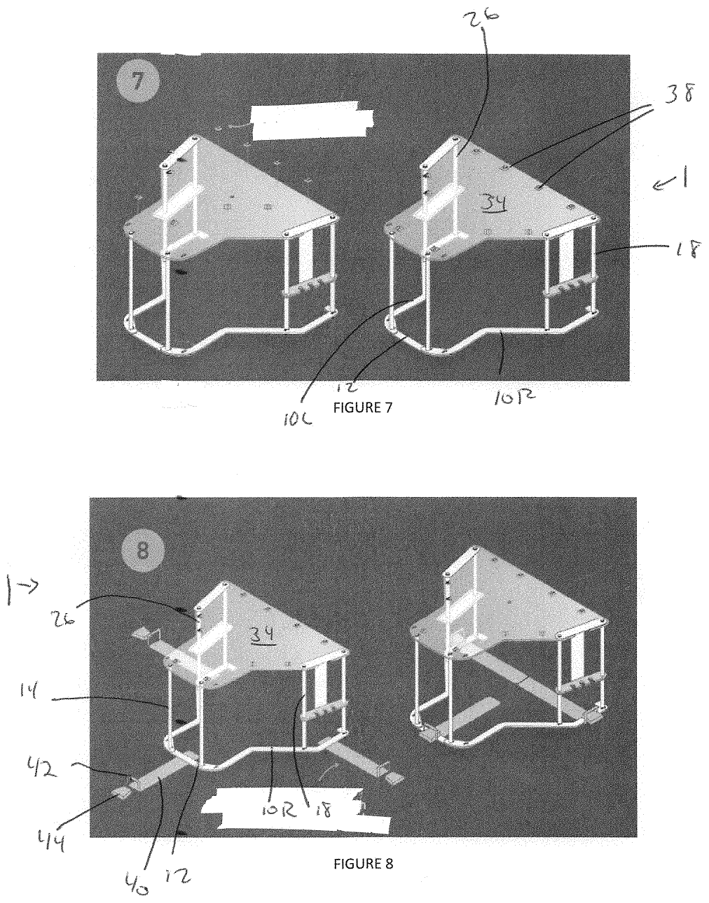

In one embodiment, FIG. 8 shows an optional mounting arrangement for barrier 1. As noted above, barrier 1 is intended to cover a patient's head and upper shoulders during a dental or hygienic procedure which is typically done with the patient lying in a reclined dental chair. In one embodiment, a series of three support braces 40 may be secured to the upper surface of a head area of a dental chair, one directed towards frame base connector 12 and the other two towards lateral frame bases 10L and 10R respectively. This provides a stable base on which to rest barrier 1 during use. Support braces 40 can be glued, bolted, taped, or otherwise connected to a dental chair in a manner preferred by the user.

Support braces are ideally wide flat aluminum or polymer braces with an upturned distal opening 42. Braces 40 are positioned to pass under frame base connector 12 and lateral frame bases 10L and 1OR so that distal opening 42 curves around them to hold them in place. Angled locking wedges 44 can then be placed through openings 42 and over frame base connector 12 and lateral frame bases 10L and 10R securing barrier 1 to the three braces 40.

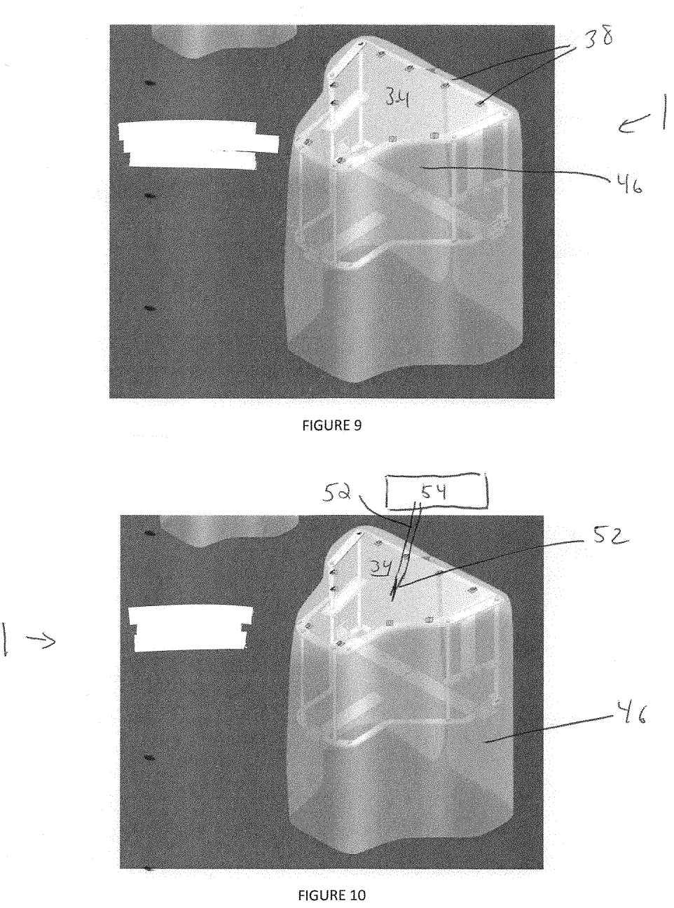

As shown in FIG. 9, once barrier 1 is constructed and connected to braces 40 a disposable plastic sheeting 46 is clipped around the entire open perimeter, attached to plastic clips 38. This completes the full aerosol barrier 1. An opening can be left in plastic sheeting 46 in the back of barrier 1 for the patent to place their head and upper shoulders within.

In one embodiment illustrated in FIG. 10 once barrier 1 is completed, a vacuum hose 50 connected to a vacuum pump 54 maybe passed through plastic sheeting 46 and though a vacuum opening 52 in the center of polycarbonate top 36. This vacuum hose 50 can generate a negative pressure within barrier 1 and plastic sheeting to keep aerosols from the patient from escaping into the room. Optional second vacuum hosing may be added at other locations if a different position is preferred by the user, depending on the angles need for viewing and access during the procedure.

As illustrated in FIG. 10 the dentist's instruments are also located in instrument support 18 under plastic sheeting 46 so that there is no need for the dentist or hygienist to constantly be removing their hands from barrier 1. It is understood that the dentists and hygienists can cut small openings in plastic sheeting 46, typically by the head region of barrier 1 so that they can fit their hands in to the patient. Although this will create an opening in barrier 1 it is small, and with the added vacuum hose 50 and negative pressure air flow through such opening, the airflow would be inward and prevent aerosols from escaping.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A barrier for dental or medical procedures on patient, said barrier comprising:
a frame;
a clear top connected to the frame; and
a disposable plastic sheeting connected around substantially an entire perimeter of said clear top, said disposable plastic sheeting covering said frame,
wherein said frame is supportable on a chair or table for supporting patient, said barrier intended to cover at least a head and portion of shoulders of a patient.

2. The barrier as claimed in claim 1, wherein said frame has a base formed of a pair of left and right lateral frame bases connected together via a frame base connector.

3. The barrier as claimed in claim 2, wherein said frame further comprises a plurality of vertical support rods that extend upwards from said left and right lateral frame bases and said frame base connector.

4. The barrier as claimed in claim 3, wherein said barrier further comprises at least one of an instrument holder 18 or an instrument tray 26, connected to at least one of said vertical support rods.

5. The barrier as claimed in claim 4, wherein said clear top is attached to the top of said vertical support rods, fixing in place said instrument holder 18 or said instrument tray 26.

6. The barrier as claimed in claim 4, wherein said clear top is made of polycarbonate.

7. The barrier as claimed in claim 5, wherein said instrument holder is formed of an instrument clip, a vertical rail, and a top piece.

8. The barrier as claimed in claim 5, wherein said instrument tray is formed of an instrument tray, a vertical rail, and a top piece.

9. The barrier as claimed in claim 7, wherein said clear plastic top has at least one notch for receiving said vertical rail of said instrument holder, and where when said clear plastic top is secured to said vertical support rods, said vertical rail passes through said receiving notch and said top piece of said instrument holder rests on top of said clear plastic top.

10. The barrier as claimed in claim 8, wherein said clear plastic top has at least one notch for receiving said vertical rail of said instrument tray, and where when said clear plastic top is secured to said vertical support rods, said vertical rail passes through said receiving notch and said top piece of said instrument tray rests on top of said clear plastic top.

11. The barrier as claimed in claim 9, wherein said clear plastic top includes a plurality of plastic clips disposed on top and around the periphery configured to maintain said disposable plastic sheeting, such that said disposable plastic sheeting cover said frame and said instrument holder attached to said vertical support rods.

12. The barrier as claimed in claim 10, wherein said clear plastic top includes a plurality of plastic clips disposed on top and around the periphery configured to maintain said disposable plastic sheeting, such that said disposable plastic sheeting cover said frame and said instrument tray attached to said vertical support rods.

13. The barrier as claimed in claim 1, wherein said clear top of further comprises an opening for a vacuum tube, allowing for generation of a negative air pressure within said disposable plastic sheeting.
